(19) United States
(12) Patent Application Publication
(10) Pub. No.: US 2014/0345040 A1
(43) Pub. Date: Nov. 27, 2014

(54) SWIMMING POOL DESIGN

(71) Applicant: JEAN PIERRE, DALLAS, TX (US)

(72) Inventor: JEAN PIERRE, DALLAS, TX (US)

(21) Appl. No.: 14/286,987

(22) Filed: May 24, 2014

Related U.S. Application Data
(60) Provisional application No. 61/827,377, filed on May 24, 2013.

(51) Int. Cl. E04H 4/14; A01K 63/00

(52) U.S. Cl. CPC E04H 4/145; A01K 63/003
USPC 4/489

(57) ABSTRACT

A personal immersion tank and aquarium combination, comprising a first tank having vertical walls and a bottom for allowing water to be contained therein, wherein one of the walls at least is translucent for viewing therefrom, a second tank disposed adjacent the first tank and constructed to contained sea life and water for supporting such sea life, the second tank having vertical sides and a bottom with a portion of the vertical sides adjacent to and in contact with the at least one translucent wall of the first tank being also translucent such that a viewer that is positioned outside of both the first tank and the second tank can see through the walls of the second tank to the first tank and a person immersed in the first tank can see through the walls of the second tank through the at least one translucent wall in the first tank.

### CROSS-REFERENCE TO RELATED APPLICATIONS

This application claims the benefit of U.S. Provisional Patent No. 61/827,377, filed on May 24, 2013, entitled SWIMMING POOL DESIGN, which is incorporated by reference in its entirety.

### BRIEF DESCRIPTION OF THE DRAWINGS

For a more complete understanding, reference is now made to the following description taken in conjunction with the accompanying Drawings in which:

FIG. 1A illustrates one embodiment of a structure where one portion is a swimming pool and another portion is an aquarium, which share a common wall;

FIG. 1B illustrates one embodiment of a top view of the structure of FIG. 1A;

FIG. 1C illustrates one embodiment of a side view of one of the walls of the structure of FIG. 1A;

FIG. 1D illustrates one embodiment of a side view of yet another wall of the structure of FIG. 1A;

FIG. 1E illustrates one embodiment of an end view of yet another two walls of the structure of FIG. 1A;

FIG. 2 illustrates one embodiment of the common wall of the structure of FIG. 1A;

FIG. 3 illustrates one embodiment of the structure of FIG. 1A that includes swimming pool equipment and aquarium equipment;

FIG. 4 illustrates one embodiment of the structure of FIG. 1A, the aquarium portion positioned to share two walls with the swimming pool portion;

FIG. 5 illustrates one embodiment of the structure of FIG. 1A, the aquarium portion positioned to share three walls with the swimming pool portion;

FIG. 6A illustrates a perspective view of one embodiment of the structure of FIG. 1A, wherein the structure of FIG. 1A includes a curved outer wall;

FIG. 6B illustrates a top view of one embodiment of the structure of FIG. 1A, wherein the structure of FIG. 1A includes a curved outer wall;

FIG. 7A illustrates a perspective of one embodiment of the structure of FIG. 1A, wherein the structure of FIG. 1A includes a second aquarium positioned opposite the first aquarium;

FIG. 7B illustrates a top view of one embodiment of the structure of FIG. 1A, wherein the structure of FIG. 1A includes a second aquarium positioned opposite the first aquarium;

FIG. 8A illustrates a top view of one embodiment of the structure of FIG. 1A, wherein the structure of FIG. 1A includes a single aquarium and two adjacent swimming pools;

FIG. 8B illustrates a possible cross-sectional view of one embodiment of the structure of FIG. 8A;

FIG. 8C illustrates another possible cross-sectional view of one embodiment of the structure of FIG. 8A;

FIG. 9A illustrates a top view of one embodiment of the structure of FIG. 1A, wherein the aquarium surrounds the swimming pool;

FIG. 9B illustrates a possible cross-sectional view of one embodiment of the structure of FIG. 9A;

FIG. 10A illustrates a top view of one embodiment of the structure of FIG. 9A, wherein the structure is anchored to a wall.

FIG. 10B illustrates a top view of one embodiment of the structure of FIG. 10A;

FIG. 11A illustrates a top view of one embodiment of the structure of FIG. 1A, wherein the aquarium surrounds the swimming pool;

FIG. 11B illustrates a top view of one embodiment of the structure of FIG. 11A, wherein one or more walkways is included;

FIG. 11C illustrates a top view of one embodiment of the structure of FIG. 11A, wherein the aquarium is larger on one side of the swimming pool;

FIG. 11D illustrates a top view of one embodiment of the structure of FIG. 11A, wherein the structure is curved; and

FIG. 11E illustrates a top view of one embodiment of the structure of 11D, wherein the structure includes two aquariums.

### DETAILED DESCRIPTION

Referring now to the drawings, wherein like reference numbers are used herein to designate like elements throughout, the various views and embodiments of a swimming pool design are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Swimming pools and aquariums commonly have relatively standard designs. While combinations of swimming pools and aquariums exist, the aquarium is typically placed within or otherwise supported by the swimming pool to allow people in the swimming pool to see the aquarium. However, this makes it difficult for those outside of the swimming pool to see the aquarium, as the water level of the aquarium must rise above the water level of the swimming pool in order for the contents of the aquarium to be easily viewable from outside the swimming pool. This requirement diminishes the design options and may be less visually pleasing. Furthermore, as such swimming pools are typically in-ground, neither the swimmers nor the contents of the aquarium are easily visible from outside the swimming pool. Accordingly, a design that addresses these issues may be desirable for facilities that want to maximize the visual impact of the swimming pool/aquarium combination.

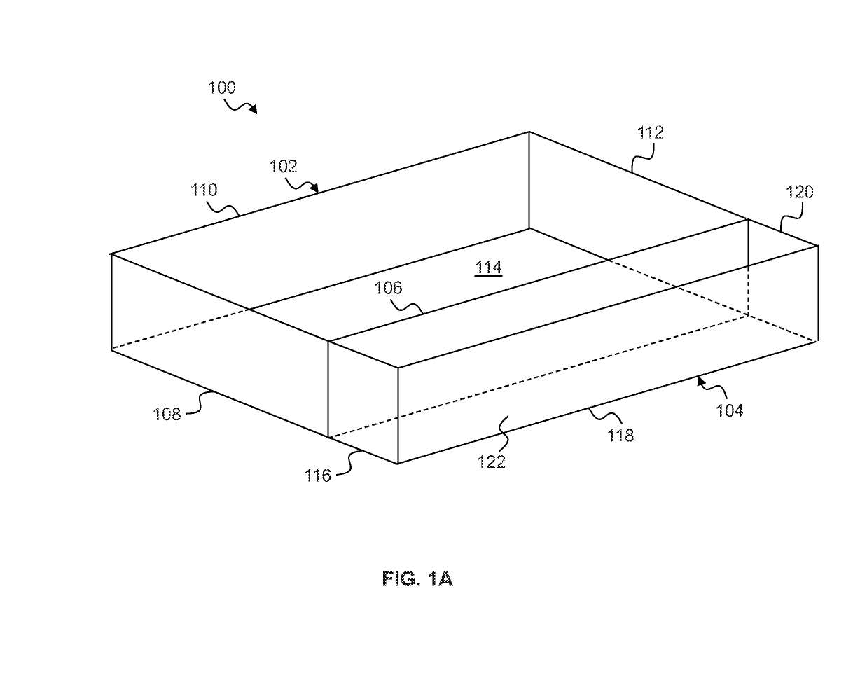

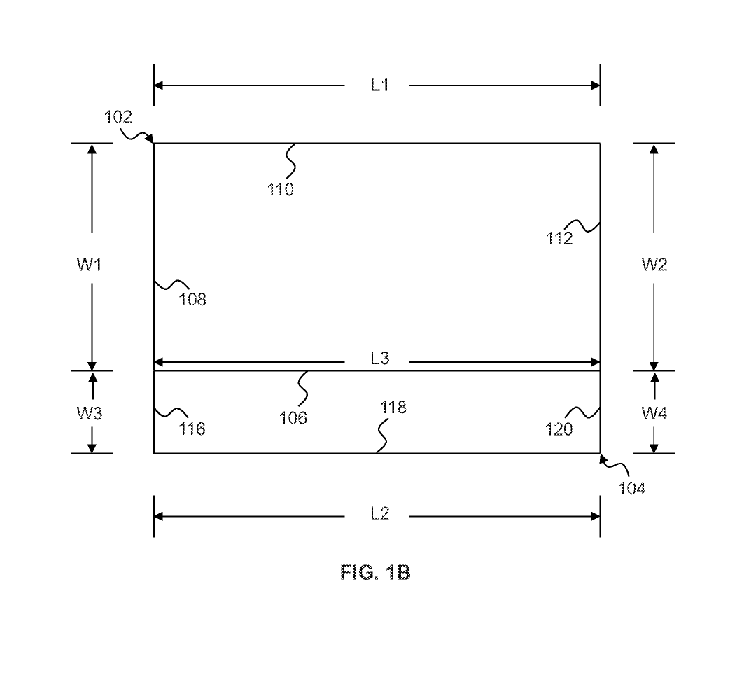

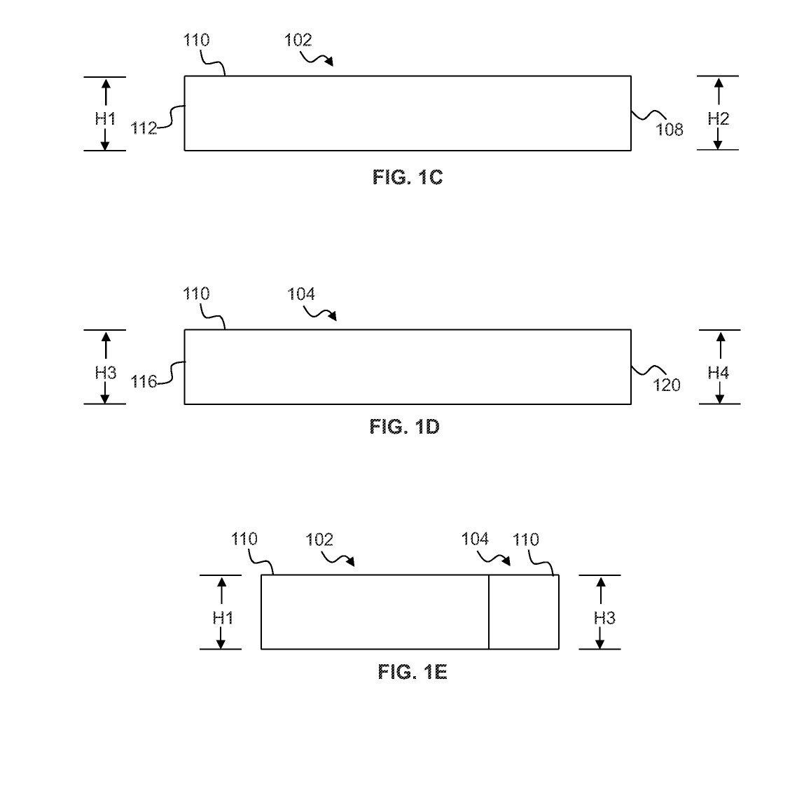

Referring to FIG. 1A, one embodiment of a structure 100 is illustrated with one portion that is a swimming pool 102 and another portion that is an aquarium 104. In the present example, the swimming pool 102 is substantially rectangular in shape and includes walls 106, 108, 110, and 112, and a floor 114. The swimming pool 102 and aquarium 104 share the wall 106, and the aquarium 104 further includes walls 116, 118, and 120 and a floor 122, and is also substantially rectangular in shape. In some embodiments, the aquarium 104 may also include a partial or complete top (not shown) that partially or completely shields the aquarium from the environment, may be transparent, and/or may be strong enough to be used as a walkway. It is understood that the aquarium 104 (and any aquarium discussed herein) may actually be two or more distinct aquariums, rather than the single aquarium shown in the present embodiment.

At least the common wall 106 and the wall 118 are made of a material (e.g., glass or plastic) that is relatively transparent, thereby allowing a user to see through the wall 118, through the wall 106, and into the swimming pool 102. This requires that the wall 118 is viewable, meaning that the wall 118 is either above ground (e.g., some or all of the swimming pool 102 and aquarium 104 are above ground) or that the wall 118 is set into another wall or area where it is viewable (e.g., in a below ground level room such as a restaurant, lounge, or other area). In some embodiments, the swimming pool 102 and aquarium 104 may be completely or partially above ground. In such embodiments, most or all of the walls 106, 108, 110, 112, 116, 118, and/or 120, as well as the floors 114 and/or 122 may be transparent. It is noted that although the swimming pool 102 is larger than the aquarium 104 in the present embodiment, in other embodiments the aquarium may be larger than the swimming pool or the aquarium and the swimming pool may be the same size.

With additional reference to FIG. 1B, a top view of the structure 100 of FIG. 1A is provided. In the present example, the swimming pool 102 has a length L1 defined by wall 110 and a length L3 defined by the common wall 106. The aquarium 104 has a length L2 defined by wall 118 and length L3 defined by the common wall 106. As the swimming pool 102 and aquarium 104 are rectangles of the same length, the lengths L1, L2, and L3 are equal. The width of the swimming pool 102 is defined by widths W1 and W2 (which are equal in this example) provided by walls 108 and 112, respectively. The width of the aquarium 104 is defined by widths W3 and W4 (which are equal in this example) provided by walls 116 and 120, respectively.

With additional reference to FIGS. 1C-1E, additional views of the structure 100 of FIG. 1A are provided, including a side view of the wall 110 (FIG. 1C), a side view of the wall 118 (FIG. 1D), and an end view of walls 108 and 116 (FIG. 1E). Heights H1, H2, H3, and H4 are equal in the present example.

It is understood that some or all of the lengths L1-L3, widths W1-W4, and/or heights H1-H4 may be different from one another. For example, the bottom 114 of the swimming pool 102 may slope downwards from a shallower end at the wall 108 to a deeper end at the wall 112. In this case, the height H1 of wall 112 would be greater than the height H2 of wall 108. The bottom 122 of the aquarium 104 may mimic the slope of the bottom 114 or not, depending on the visual aspect desired for the structure 100.

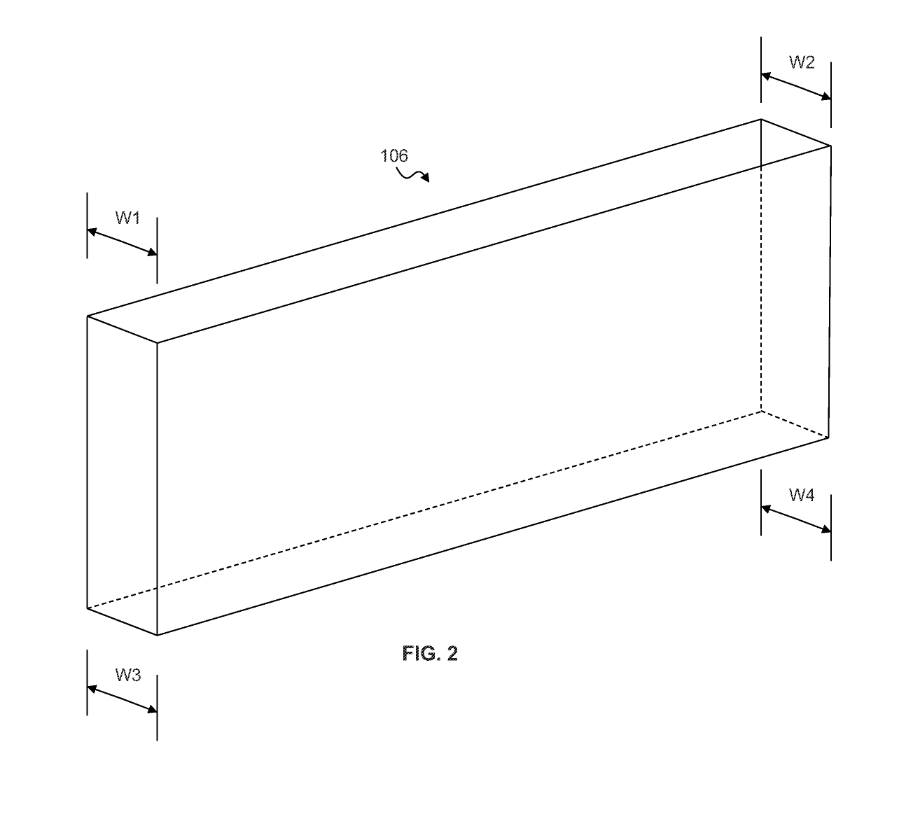

Referring to FIG. 2, one embodiment of the wall 106 is illustrated. In the present example, the wall 106 defines widths W1-W4. The widths W1-W4 may be equal or may be different depending on the particular design of the structure 100. The widths W1-W4 may typically be selected to provide optimal visibility while ensuring that the swimming pool 102 and aquarium 104 remain separated. For example, the widths W1-W4 may be selected to both contain the water present in the swimming pool 102 and aquarium 104, as well as to withstand impacts from swimmers. In some embodiments, the widths W1-W4 may be sufficient to allow one of the swimming pool 102 and aquarium 104 to be empty of water while the other is full of water, thereby allowing maintenance to be performed on the one without impacting the other. In other embodiments, the widths W1-W4 may not be sufficient for separate maintenance and a certain level of water may need to be maintained in both the swimming pool 102 and the aquarium 104 to provide support to the wall 106.

Although the wall 106 is shown as a single transparent wall in FIG. 1A and FIG. 2, it is understood that some of the wall may be translucent or opaque. For example, only the upper half may be transparent, while the lower half may be made of a non-transparent material. Accordingly, by varying the design of the wall 106, different visual designs may be implemented. In addition, while shown as a single wall, it is understood that the wall 106 may be multiple layers in some embodiments, with or without separation (e.g., air or water) between the individual layers forming the wall 106.

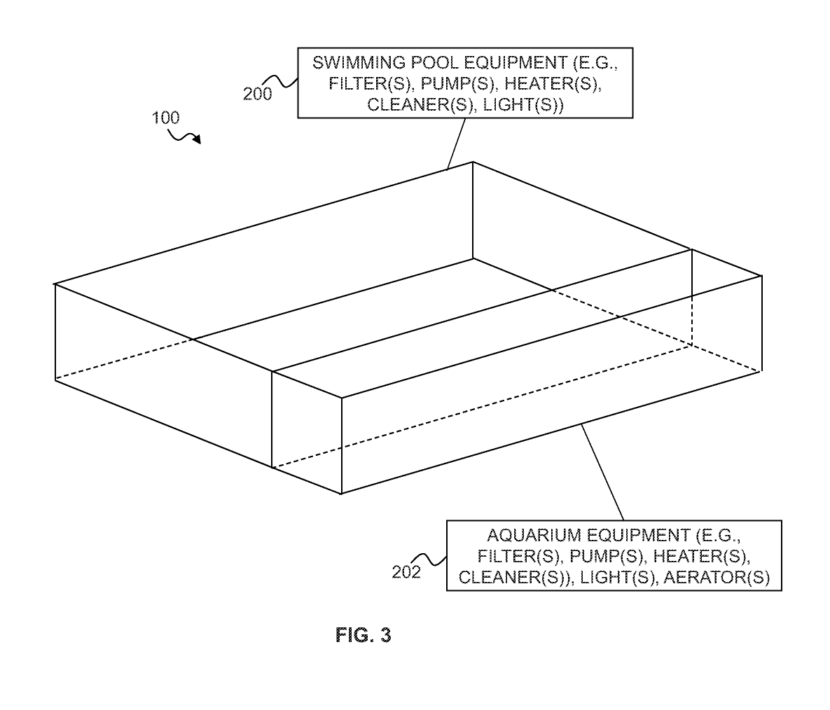

Referring to FIG. 3, one embodiment of the structure 100 of FIG. 1A is illustrated with swimming pool equipment 200 and aquarium equipment 202. The swimming pool equipment 200 may include filter(s), pump(s), heater(s), cleaner(s), light(s), and/or other equipment used in the operation and maintenance of a swimming pool. The aquarium equipment 202 may include filter(s), pump(s), heater(s), cleaner(s), light(s), and/or other equipment used in the operation and maintenance of an aquarium. The equipment 200 and 202 may include both equipment located with the swimming pool 102 and aquarium 104, as well as equipment positioned outside of the swimming pool 102 and aquarium 104.

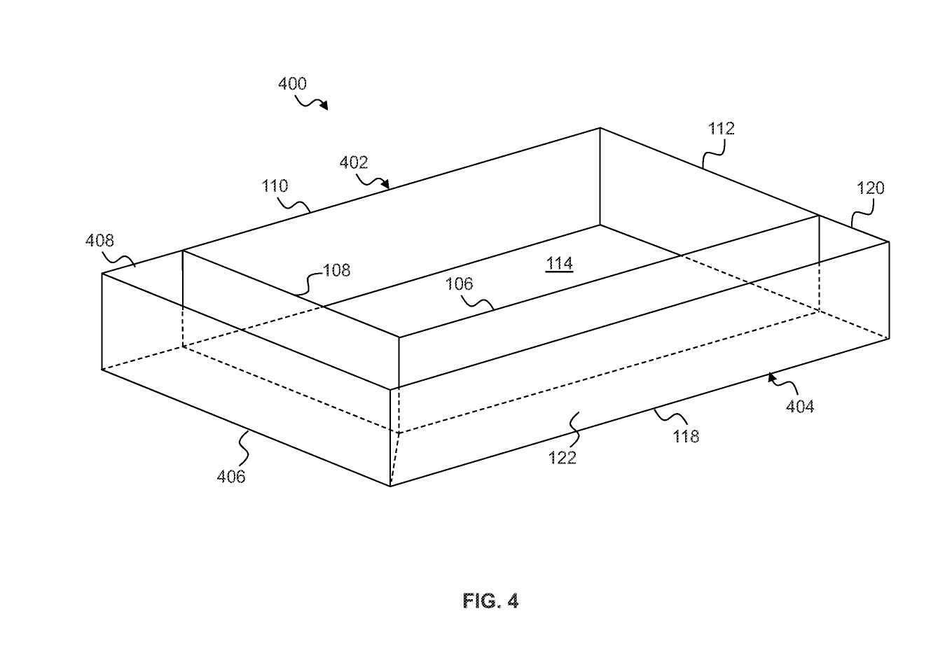

Referring to FIG. 4, one embodiment of a structure 400 is illustrated with a swimming pool 402 and an aquarium 404. The structure 400 is similar to the structure 100 of FIG. 1A and like parts are numbered as in FIG. 1A. However, the aquarium 404 of the structure 400 is positioned along the wall 108 of the swimming pool 402 as well as along wall 106 as shown in FIG. 1A. Accordingly, the aquarium 402 includes additional walls 406 and 408. At least the walls 106 and 118 are transparent as described with respect to FIG. 1A, and the walls 108 and 406 are also transparent in this embodiment.

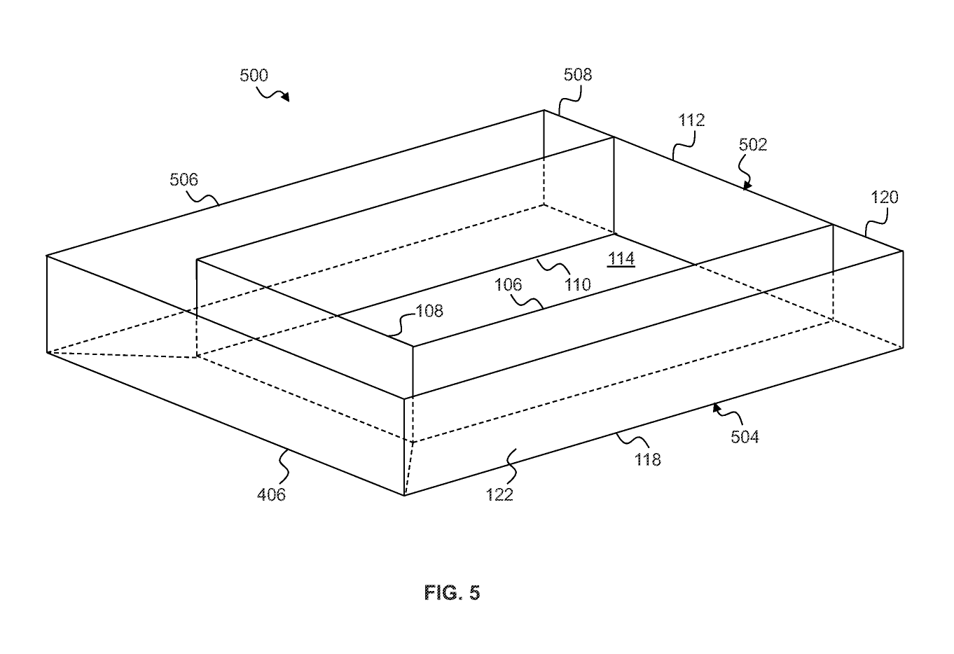

Referring to FIG. 5, one embodiment of a structure 500 is illustrated with a swimming pool 502 and an aquarium 504. The structure 500 is similar to the structure 400 of FIG. 4 and like parts are numbered as in FIG. 4. However, the aquarium 504 of the structure 500 is positioned along the wall 110 of the swimming pool 502 as well as along walls 106 and 108 as illustrated in FIG. 4. Accordingly, the aquarium 502 includes additional walls 506 and 508. At least the walls 106, 108, 118, and 402 are transparent as described with respect to FIG. 4, and the walls 110 and 506 are also transparent in this embodiment.

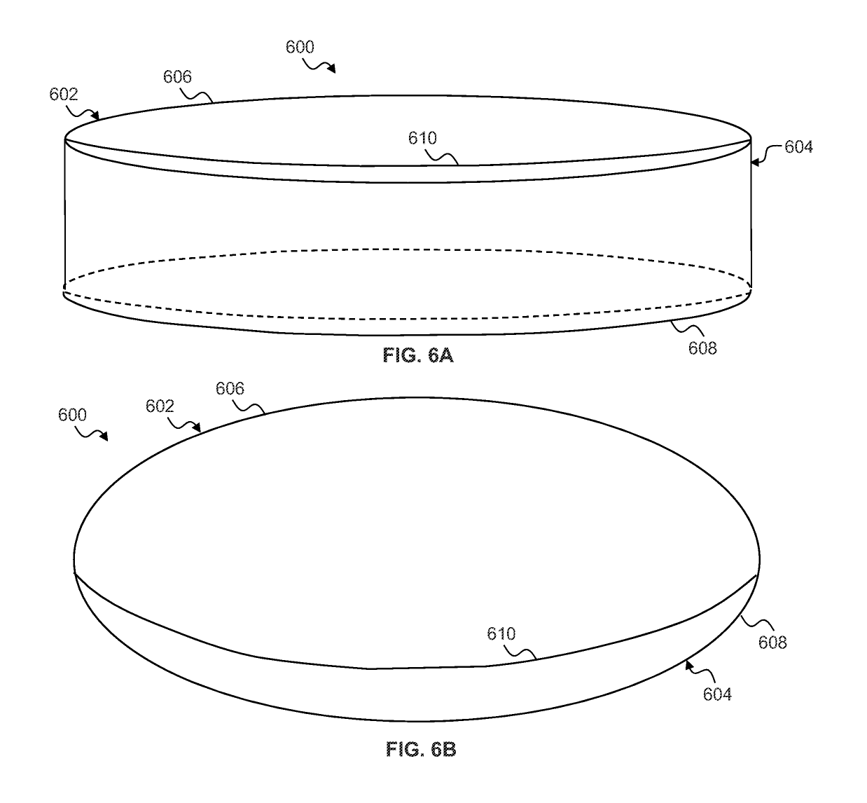

Referring to FIGS. 6A and 6B, one embodiment of a structure 600 is illustrated in perspective and top views, respectively, with a swimming pool 602 and an aquarium 604. The structure 600 is similar to the structure 100 of FIG. 1A but is different in shape. Accordingly, the swimming pool 602 includes a curved outer wall 606 (that may or may not be transparent) and a transparent inner wall 610 that is shared with aquarium 604. The aquarium 604 also has an outer wall 608 that is transparent.

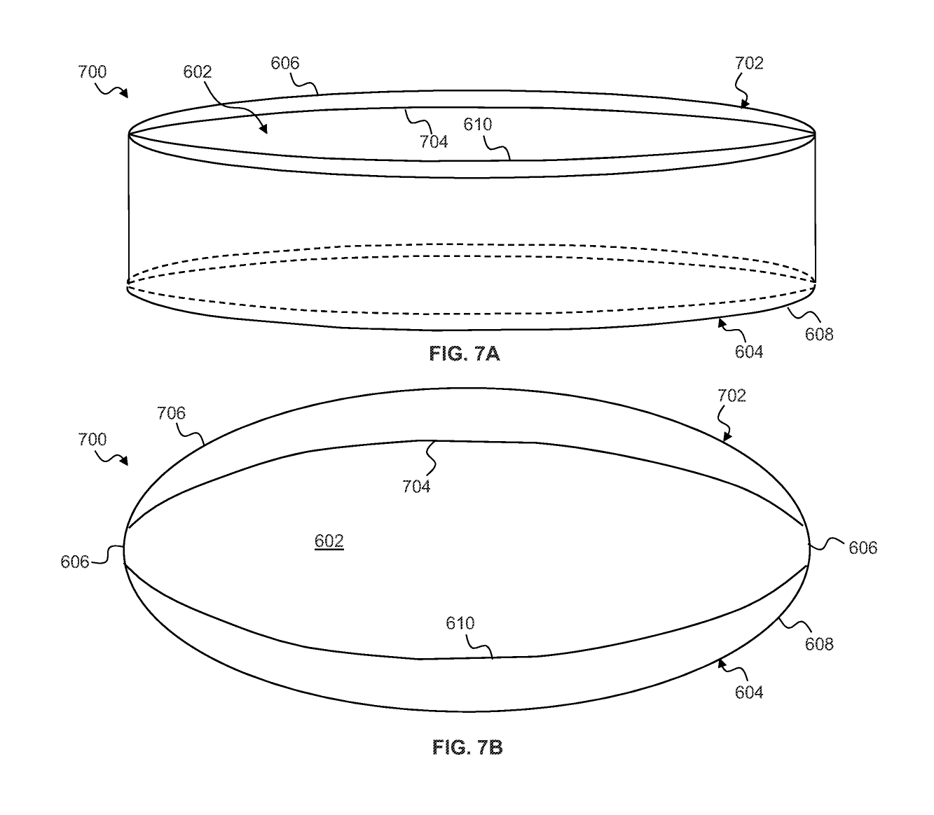

Referring to FIGS. 7A and 7B, one embodiment of a structure 700 is illustrated in perspective and top views, respectively, with a swimming pool 702 and an aquarium 704. The structure 700 is similar to the structure 600 of FIGS. 6A and 6B and like parts are numbered as in FIGS. 6A and 6B. However, the structure 700 includes a second aquarium 702 positioned opposite the aquarium 604. The aquarium 702 shares a common wall 704 with swimming pool 602 and also has a curved outer wall 706. The walls 608 and 610 are transparent as described with respect to FIGS. 6A and 6B, and the walls 704 and 706 are also transparent in this embodiment. In some embodiments, the portions of the wall 606 that are not adjacent to an aquarium may not be transparent.

Referring to the following embodiments generally, various examples of structures are illustrated. Although the swimming pool 102 and aquarium 104 are illustrated in preceding embodiments as being substantially rectangular in shape, it is understood that the structure 100 may be configured in many different ways. For example, the swimming pool may include one or more curves or other non-linear shapes and the aquarium may follow the lines of the swimming pool. In other embodiments, the aquarium may not follow the lines of the swimming pool, but may have a different shape as defined by the aquarium walls not shared with the swimming pool. Accordingly, various alternative embodiments are illustrated in the following figures, although it is understood that many other configurations may be used and the provided embodiments are for purposes of example only and are not intended to be limiting.

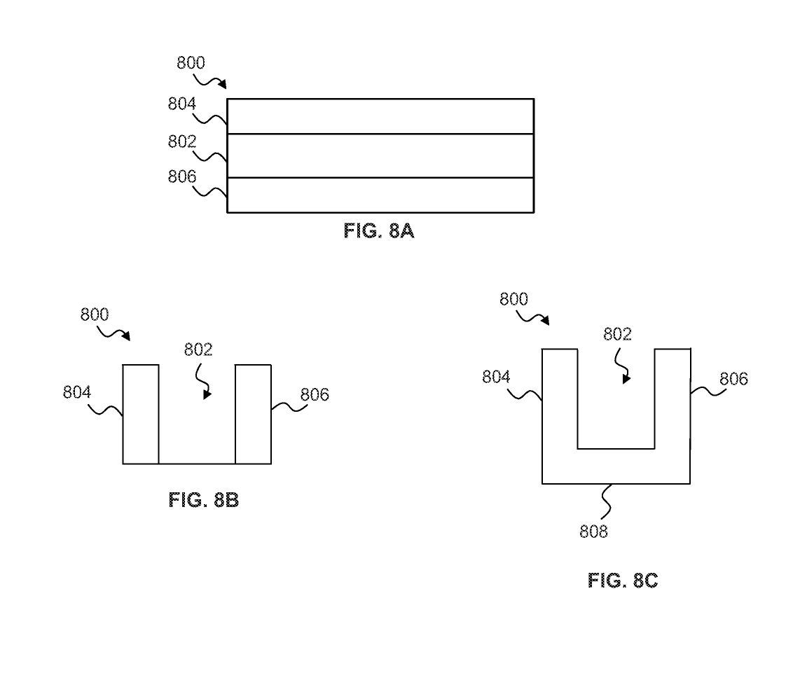

Referring to FIGS. 8A-8C, a top view of one embodiment of a structure 800 is illustrated with a swimming pool 802 and two aquariums 804 and 806. An alternative embodiment may reverse this arrangement, with a single aquarium 802 and two adjacent swimming pools 804 and 806. FIG. 8B illustrates one possible cross-sectional view, with the aquariums 804 and 806 maintained separately. FIG. 8C illustrates another possible cross-sectional view, with the aquariums 804 and 806 connected underneath the swimming pool 802 by a fluid passage 808, which may serve as the floor of the swimming pool 802 in some embodiments.

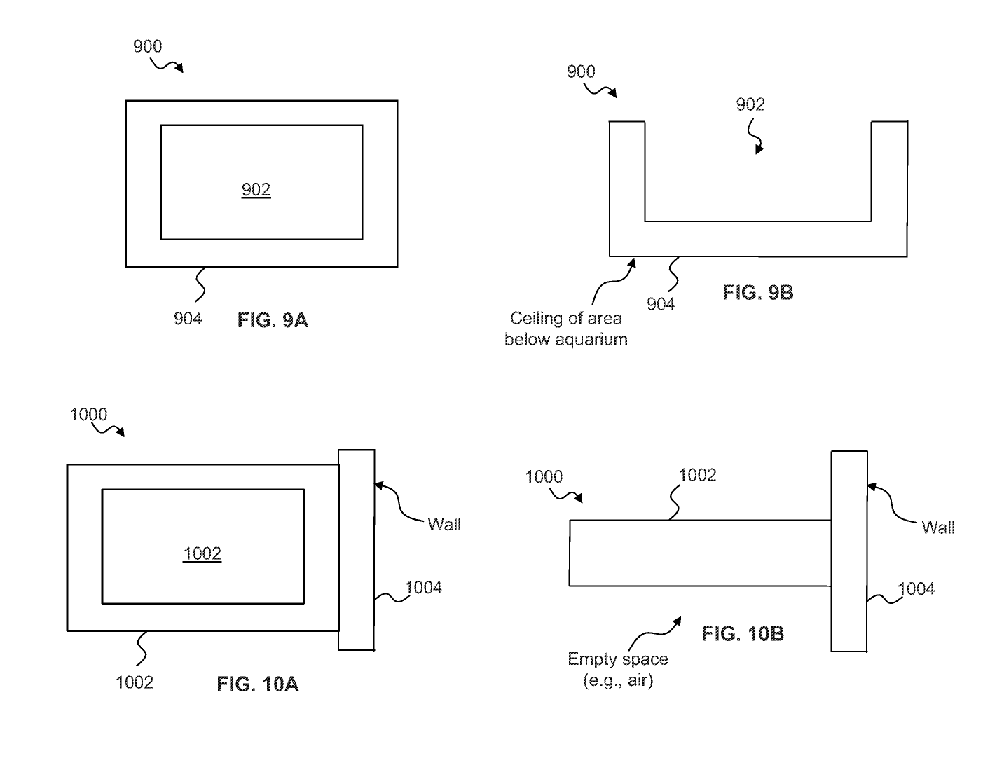

Referring to FIGS. 9A and 9B, a top view of one embodiment of a structure 900 is illustrated with a swimming pool 902 and an aquarium 904. FIG. 9B illustrates one possible cross-sectional view, with the aquarium 904 serving as some or all of the ceiling of an area underneath the aquarium 904, such as a room. Walls, columns, or other supports (not shown) in the lower area may be used to support the aquarium 904 in some embodiments.

Referring to FIGS. 10A and 10B, a top view of one embodiment of a structure 1000 is illustrated with a swimming pool 1002 and an aquarium 1004. The structure 1000 is anchored to a wall 1004. FIG. 10B illustrates one possible side view, with the aquarium 1004 overhanging an empty space.

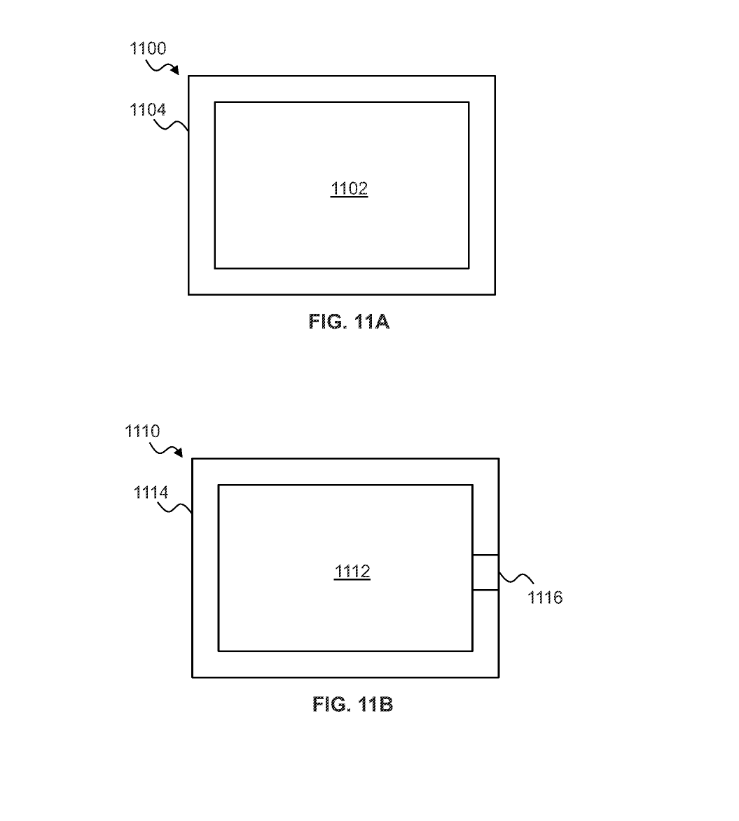

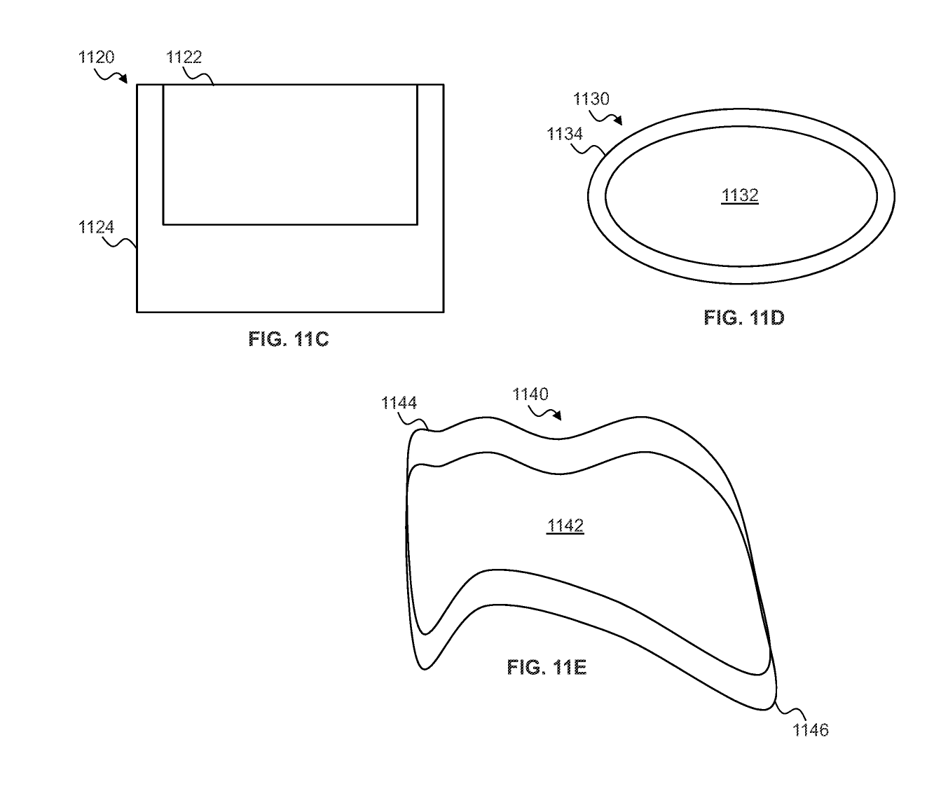

Referring to FIG. 11A, a top view of one embodiment of a structure 1100 is illustrated with a swimming pool 1102 and an aquarium 1104.

Referring to FIG. 11B, a top view of one embodiment of a structure 1110 is illustrated with a swimming pool 1112 and an aquarium 1114. One or more walkways 1116 may be positioned to provide access to the swimming pool 1112. The walkway 1116 may be over the aquarium 1114 so that the aquarium 1114 runs underneath the walkway 1116, or may run be through all or a portion of the aquarium 1114.

Referring specifically to FIG. 11C, a top view of one embodiment of a structure 1120 is illustrated with a swimming pool 1122 and an aquarium 1124. As illustrated, the aquarium 1124 is larger on one side of the swimming pool 1122 than on the other two sides.

Referring specifically to FIG. 11D, a top view of one embodiment of a structure 1130 is illustrated with a swimming pool 1132 and an aquarium 1134.

Referring specifically to FIG. 11E, a top view of one embodiment of a structure 1140 is illustrated with a swimming pool 1142 and two aquariums 1144 and 1146.

Although the aquariums described herein are generally illustrated as positioned on the ground or in the ground, it is understood that they may be positioned in other ways. For example, an aquarium may be suspended (e.g., by cables), placed on a stand or other structure, wrapped around a column, or otherwise supported. Accordingly, the disclosure herein is directed to the placement of an aquarium relative to a swimming pool and need not be limited to particular support structures.

Although the preferred embodiment has been described in detail, it should be understood that various changes, substitutions and alterations can be made therein without departing from the spirit and scope of the invention.

What is claimed is:

1. A personal immersion tank and aquarium combination, comprising:
a first tank having vertical walls and a bottom for allowing water to be contained therein of a sufficient depth that a person can be immersed therein, wherein one of the walls at least is translucent for viewing therefrom;
a second tank disposed adjacent the first tank and constructed to contained sea life and water for supporting such sea life, the second tank having vertical sides and a bottom with a portion of the vertical sides adjacent to and in contact with the at least one translucent wall of the first tank and the side diametrically opposite with the portion adjacent to and in contact with the at least one translucent wall of the first tank being also translucent such that a viewer that is positioned outside of both the first tank and the second tank can see through the walls of the second tank to the first tank and a person immersed in the first tank can see through the walls of the second tank through the at least one translucent wall in the first tank;
wherein the translucent walls of the first and second tanks in an adjacent relationship allow for viewing of the sea life in the second tank;
the sidewalls of the second tank being of a thickness to support water when contained therein for the sustentation of the sea life contained in the second tank.

2. The personal immersion tank and aquarium combination of claim 1, wherein the at least one translucent wall for viewing therefrom in the first tank and the at least portion of the side wall adjacent thereto form a common wall for viewing there through, wherein the common wall has a thickness that will support water in the first tank when the second tank is empty.
